(19) United States
(12) Patent Application Publication
(10) Pub. No.: US 2026/0247198 A1
(43) Pub. Date: Aug. 20, 2026

(54) MAPPING BETWEEN INFERENCE PARAMETERS AND CHANNEL STATE INFORMATION REPORTING CONFIGURATIONS

(71) Applicant: QUALCOMM Incorporated, San Diego, CA (US)

(72) Inventors: Rajeev KUMAR, San Diego, CA (US); Hamed PEZESHKI, San Diego, CA (US); Aziz GHOLMIEH, Del Mar, CA (US)

(21) Appl. No.: 19/460,042

(22) Filed: Jan. 26, 2026

Related U.S. Application Data
(60) Provisional application No. 63/754,319, filed on Feb. 5, 2025.

(51) Int. Cl. H04W 24/10; H04L 41/147

(52) U.S. Cl. CPC H04W 24/10; H04L 41/147

(57) ABSTRACT

Methods, systems, and devices for wireless communications are described. A user equipment (UE) may report inference parameter sets supported by the UE to a network entity. The network entity may configure channel state information (CSI) reporting configurations for the UE, and may indicate a correspondence between the CSI reporting configurations and supported inference parameter sets. The UE may evaluate and report applicability information for the inference parameter sets and/or the CSI reporting configurations. For example, an inference parameter set may become non-applicable for CSI reporting at a UE based on changing conditions (e.g., channel or spatial conditions have changed as compared to the channel or spatial conditions used to train the relevant artificial intelligence or machine learning model by more than an allowable threshold for accuracy of the artificial intelligence or machine learning model).

### CROSS REFERENCE

The present Application for Patent claims the benefit of U.S. Provisional Patent Application No. 63/754,319 by Kumar et al., entitled “MAPPING BETWEEN INFERENCE PARAMETERS AND CHANNEL STATE INFORMATION REPORTING CONFIGURATIONS,” filed Feb. 5, 2025, assigned to the assignee hereof, and which is expressly incorporated by reference in its entirety herein.

### FIELD OF TECHNOLOGY

The following relates to wireless communications, including mapping between inference parameters and channel state information report configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications at a user equipment (UE) is described. The method may include transmitting a first control message that indicates a set of multiple inference parameter sets supported by the UE, receiving, based on the first control message, a second control message including an indication that (e.g., indicates a mapping configuration that maps) an inference parameter set of the set of multiple inference parameter sets corresponds to one or more channel state information (CSI) reporting configurations, and transmitting one or more third control messages. In some examples, the one or more third control messages may indicate whether the interference parameter set is applicable or non-applicable for CSI information reporting based on the second control message (e.g., the mapping configuration).

A UE is described. The UE may include one or more memories storing processor executable code, and one or more processors coupled with the one or more memories. The one or more processors may individually or collectively be operable to execute the code to cause the UE to transmit a first control message that indicates a set of multiple inference parameter sets supported by the UE, receive, based on the first control message, a second control message including an indication that an inference parameter set of the set of multiple inference parameter sets corresponds to one or more CSI reporting configurations, and transmit one or more third control messages. In some examples, the one or more third control messages may indicate whether the interference parameter set is applicable or non-applicable for CSI information reporting based on the second control message.

Another UE is described. The UE may include means for transmitting a first control message that indicates a set of multiple inference parameter sets supported by the UE, means for receiving, based on the first control message, a second control message including an indication that an inference parameter set of the set of multiple inference parameter sets corresponds to one or more CSI reporting configurations, and means for transmitting one or more third control messages. In some examples, the one or more third control messages may indicate whether the interference parameter set is applicable or non-applicable for CSI information reporting based on the second control message.

A non-transitory computer-readable medium storing code is described. The code may include instructions executable by one or more processors to transmit a first control message that indicates a set of multiple inference parameter sets supported by the UE, receive, based on the first control message, a second control message including an indication that an inference parameter set of the set of multiple inference parameter sets corresponds to one or more CSI reporting configurations, and transmit one or more third control messages. In some examples, the one or more third control messages may indicate whether the interference parameter set is applicable or non-applicable for CSI information reporting based on the second control message.

In some examples of the method, UEs, and non-transitory computer-readable medium described herein, the second control message indicates that a first inference parameter set of the set of multiple inference parameter sets may be one-to-one mapped to a first CSI reporting configuration of the one or more CSI reporting configurations.

In some examples of the method, UEs, and non-transitory computer-readable medium described herein, the second control message indicates that a second inference parameter set of the set of multiple inference parameter sets may be one-to-one mapped to a second CSI reporting configuration of the one or more CSI reporting configurations.

In some examples of the method, UEs, and non-transitory computer-readable medium described herein, transmitting the one or more third control messages may include operations, features, means, or instructions for transmitting, after reception of the second control message, a third control message indicating that the first inference parameter set may be applicable or non-applicable for CSI reporting.

Some examples of the method, UEs, and non-transitory computer-readable medium described herein may further include operations, features, means, or instructions for evaluating, after reception of the second control message, respective applicability statuses for the first inference parameter set, the first CSI reporting configuration, the second inference parameter set, the second CSI reporting configuration, and a third inference parameter set of the set of multiple inference parameter sets.

In some examples of the method, UEs, and non-transitory computer-readable medium described herein, transmitting the one or more third control messages may include operations, features, means, or instructions for transmitting a third control message indicating that the first inference parameter set may be applicable or non-applicable for CSI reporting based on the first inference parameter set or the first CSI reporting configuration becoming applicable or non-applicable for CSI reporting at the UE in accordance with the evaluating.

In some examples of the method, UEs, and non-transitory computer-readable medium described herein, the second control message indicates that the inference parameter set may be mapped to a set of multiple CSI reporting configurations.

In some examples of the method, UEs, and non-transitory computer-readable medium described herein, the second control message indicates that a second inference parameter set of the set of multiple inference parameter sets may be mapped to a second set of multiple CSI reporting configurations.

Some examples of the method, UEs, and non-transitory computer-readable medium described herein may further include operations, features, means, or instructions for evaluating, after reception of the second control message, respective applicability statuses for the inference parameter set, the set of multiple CSI reporting configurations, the second inference parameter set, the second set of multiple CSI reporting configurations, and a third inference parameter set of the set of multiple inference parameter sets.

In some examples of the method, UEs, and non-transitory computer-readable medium described herein, transmitting the one or more third control messages may include operations, features, means, or instructions for transmitting a third control message indicating that the inference parameter set may have become applicable or non-applicable for CSI reporting at the UE in accordance with the evaluating.

In some examples of the method, UEs, and non-transitory computer-readable medium described herein, transmitting the one or more third control messages may include operations, features, means, or instructions for transmitting a third control message indicating that at least one CSI reporting configuration of the set of multiple CSI reporting configurations may have become applicable or non-applicable for CSI reporting at the UE in accordance with the evaluating.

In some examples of the method, UEs, and non-transitory computer-readable medium described herein, the second control message indicates the inference parameter set may be mapped to a set of multiple CSI reporting configurations and that each of the set of multiple CSI reporting configurations may be mapped to multiple inference parameter sets of the set of multiple inference parameter sets.

Some examples of the method, UEs, and non-transitory computer-readable medium described herein may further include operations, features, means, or instructions for evaluating, after reception of the second control message, respective applicability statuses for the set of multiple CSI reporting configurations, the multiple inference parameter sets, and a second inference parameter set of the set of multiple inference parameter sets.

In some examples of the method, UEs, and non-transitory computer-readable medium described herein, transmitting the one or more third control messages may include operations, features, means, or instructions for transmitting a third control message indicating that the inference parameter set may have become applicable or non-applicable for CSI reporting at the UE in accordance with the evaluating.

In some examples of the method, UEs, and non-transitory computer-readable medium described herein, transmitting the one or more third control messages may include operations, features, means, or instructions for transmitting a third control message indicating that at least one CSI reporting configuration of the set of multiple CSI reporting configurations may have become applicable or non-applicable for CSI reporting at the UE in accordance with the evaluating.

Some examples of the method, UEs, and non-transitory computer-readable medium described herein may further include operations, features, means, or instructions for receiving one or more reference signals in accordance with the one or more CSI reporting configurations and transmit one or more CSI reports in accordance with the one or more CSI reporting configurations, where the one or more CSI reports include predicted beam measurement values based on the one or more reference signals in accordance with the inference parameter set.

In some examples of the method, UEs, and non-transitory computer-readable medium described herein, the second control message indicates a mapping configuration that maps the inference parameter set of the plurality of inference parameter sets to the one or more CSI reporting configurations.

Details of one or more implementations of the subject matter described in this disclosure are set forth in the accompanying drawings and the description below. Other features and aspects will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports mapping between inference parameters and channel state information (CSI) report configurations in accordance with one or more aspects of the present disclosure.

FIG. 2 shows an example of a wireless communications system that supports mapping between inference parameters and CSI reporting configurations in accordance with one or more aspects of the present disclosure.

FIG. 3 shows an example of a process flow that supports mapping between inference parameters and CSI reporting configurations in accordance with one or more aspects of the present disclosure.

FIG. 4 shows an example of a process flow that supports mapping between inference parameters and CSI reporting configurations in accordance with one or more aspects of the present disclosure.

FIG. 5 shows an example of an inference parameter set to CSI reporting configuration mapping diagram that supports mapping between inference parameters and CSI reporting configurations in accordance with one or more aspects of the present disclosure.

FIG. 6 shows an example of an inference parameter set to CSI reporting configuration mapping diagram that supports mapping between inference parameters and CSI reporting configurations in accordance with one or more aspects of the present disclosure.

FIG. 7 shows an example of an inference parameter set to CSI reporting configuration mapping diagram that supports mapping between inference parameters and CSI reporting configurations in accordance with one or more aspects of the present disclosure.

FIGS. 8 and 9 show block diagrams of devices that support mapping between inference parameters and CSI reporting configurations in accordance with one or more aspects of the present disclosure.

FIG. 10 shows a block diagram of a communications manager that supports mapping between inference parameters and CSI reporting configurations in accordance with one or more aspects of the present disclosure.

FIG. 11 shows a diagram of a system including a device that supports mapping between inference parameters and CSI reporting configurations in accordance with one or more aspects of the present disclosure.

FIG. 12 shows a flowchart illustrating methods that support mapping between inference parameters and CSI reporting configurations in accordance with one or more aspects of the present disclosure.

### DETAILED DESCRIPTION

In some wireless communications systems, channel state information (CSI) may be obtained (e.g., based on measurements of one or more reference signals) to evaluate the characteristics of a wireless channel. Communications parameters for the wireless channel may be selected based on the evaluated characteristics. For example, CSI information included in a CSI report may include characteristics related to beams for communication between a user equipment (UE) and a network entity, and one or more beams may be selected for communication between the UE and the network entity based on the reported channel characteristics associated with the beams. In some examples, a user equipment (UE) may use one or more artificial intelligence (AI) or machine learning (ML) models or functionalities to perform predictions of beam characteristics (e.g., to perform beam prediction). In some examples, the UE may measure one or more reference signals (e.g., synchronization signal blocks (SSBs) or CSI-reference signals (CSI-RSs)) that correspond to a set of beams via a first set of resources, which may be referred to as Set B beams, during a first set of measurement occasions. The UE may perform beam prediction (e.g., inference, assumption) for a set of beams associated with a second set of resources, which may be referred to as Set A beams, using the AI/ML model or functionality based on the historical or actual measurement results of the Set B beams. For example, the UE may use various measurements of one or more Set B beams to predict one or more measurements for the Set A beams. The UE may include the predicted measurements for the Set A beams in a CSI report. The network entity may use the predicted beam measurement results to select a beam for communication with the UE.

In some examples, the UE may perform the beam prediction (e.g., temporal beam prediction, spatial beam prediction) using the AI/ML model or functionality in accordance with a set of inference parameters, such as a Set B beam measurement window length, a Set B beam measurement periodicity, and/or a prediction duration for Set A beams. The UE may report inference parameter sets supported by the UE to the network entity. Based on the reported inference parameter sets supported by the UE, the network entity may configure CSI reporting configurations (e.g., via radio resource control (RRC) signaling) for the UE to measure the Set B beams and to report the predicted measurements. For example, inference parameters within an inference parameter set may include Set A beam information, set B beam information, an associated identifier (ID) for a trained AI/ML model, CSI report related information, and/or timing information for measurements or predictions. An inference parameter set may become non-applicable at a UE based on changing conditions (e.g., channel or spatial conditions have changed as compared to the channel or spatial conditions used to train the relevant AI/ML model to an extent the AI/ML model may no longer be accurate, or an AI/ML model associated with the inference parameter set may no longer be available at the UE).

Aspects of this disclosure relate to mapping of CSI reporting configurations to inference parameter sets. For example, by indicating a correspondence (e.g., a mapping) between inference parameter set(s) and a CSI reporting configuration(s), the UE may indicate to the network which inference parameter set and/or CSI reporting configurations are applicable and/or non-applicable (e.g., for CSI reporting) in accordance with the correspondence (e.g., the mapping). By indicating which inference parameter sets and/or CSI reporting configurations are applicable and/or non-applicable, the network entity may determine which CSI reports will be received and the parameters that will be reported in the CSI reports. The network entity may select communications parameters (e.g., beams) for communication with the UE based on the information reported in a CSI report. Accordingly, indicating the correspondence (e.g., the mapping_ between inference parameter set(s) and CSI reporting configuration(s) may enable consistency associated with expected CSI reports, which may enable efficient communications between the UE and the network entity.

In some examples, if inference parameter sets are one-to-one mapped to CSI reporting configurations, the UE may indicate to the network that a given inference parameter set has become non-applicable, which may inherently indicate to the network that the corresponding CSI reporting configuration (e.g., the mapped CSI reporting configuration) has also become non-applicable. Similarly, if inference parameter sets are one-to-multiple mapped to CSI reporting configurations, the UE may indicate to the network that a given inference parameter set has become non-applicable, which may inherently indicate to the network that the corresponding CSI reporting configurations (e.g., the mapped CSI reporting configurations) have also become non-applicable. In a one-to-multiple mapping scenario, if one of multiple CSI reporting configurations corresponding (e.g., mapped) to an inference parameter set becomes non-applicable, the UE may indicate which CSI reporting configuration became non-applicable. As another example, if inference parameter sets have a multiple-to-multiple correspondence (e.g., multiple-to-multiple mapped) to CSI reporting configurations, the UE may evaluate and may indicate individually which inference parameter sets and/or CSI reporting configurations are non-applicable. Accordingly, the type of correspondence (e.g., mapping) may indicate which inference parameter sets and CSI reporting configurations to evaluate and report for applicability. Thus, indicating the type of correspondence (e.g., mapping) may enable the UE to determine how to report the applicability and/or non-applicability of inference parameter set(s) and CSI reporting configuration(s). As described herein, indicating the correspondence (e.g., mapping) between inference parameter set(s) and CSI reporting configuration(s) may enable consistency associated with expected CSI reports, which may enable efficient communications between the UE and the network entity.

Aspects of the disclosure are initially described in the context of wireless communications systems. Aspects of the disclosure are further illustrated by and described with reference to process flows, inference parameter set to CSI reporting configuration mapping diagrams, apparatus diagrams, system diagrams, and flowcharts that relate to mapping between inference parameters and CSI reporting configurations.

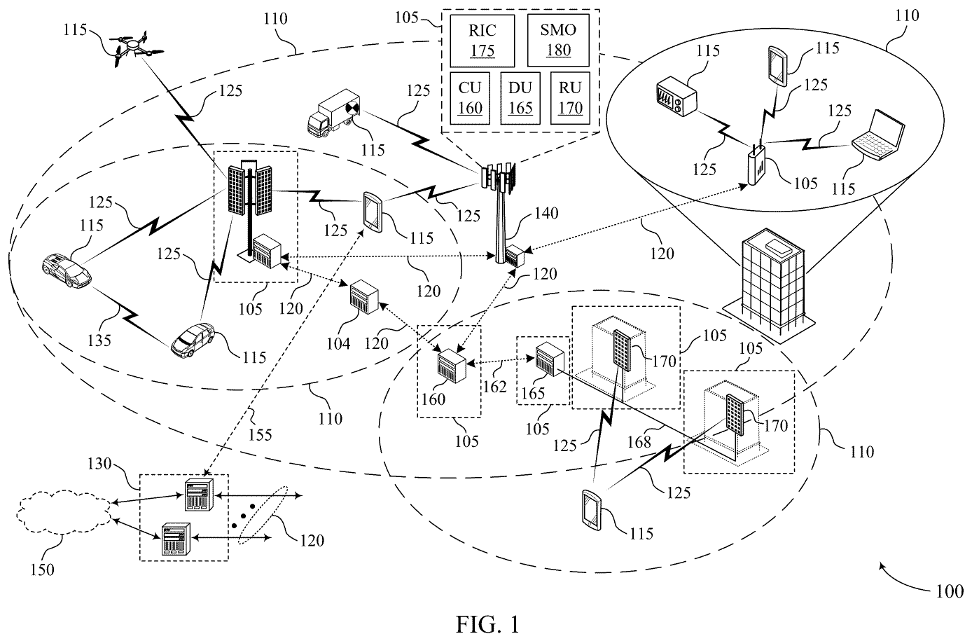

FIG. 1 shows an example of a wireless communications system 100 that supports mapping between inference parameters and CSI reporting configurations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support mapping between inference parameters and CSI reporting configurations as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, in some examples, a UE 115 may use AI or ML models or functionalities to perform predictions of beam characteristics (e.g., to perform beam prediction). For example, a UE 115 may measure one or more reference signals (e.g., SSBs or CSI-RSs) that correspond to a set of beams via a first set of resources, which may be referred to as Set B beams, during a first set of measurement occasions. The UE may perform beam prediction (e.g., inference, assumption) for a set of beams associated with a second set of resources, which may be referred to as Set A beams, using the AI/ML model/functionality based on the historical or actual measurement results of the Set B beams. For example, the UE 115 may use various measurements of one or more Set B beams to predict one or more Set A beams. The UE may include the one or more predicted measurements for the Set A beams in a CSI report. The network entity 105 may use the one or more predicted beam measurement results to select a beam for communication with the UE 115.

In some examples, the UE 115 may perform spatial downlink beam prediction for Set A beams based on measurement results of Set B beams. For example, the Set B beams may be wide beams such as SSBs, and the Set A beams may be narrower beams such as CSI-RSs. As another example, the Set B beams may be a first set of narrow beams, and the Set A beams may be another set of narrow beams.

In some examples, the UE 115 may perform temporal downlink beam prediction for Set A beams based on historical measurement results of Set B beams. For example, the Set A beams may be the same spatial beams as the Set B beams, but at a time in the future. As another example, future characteristics of the Set A beams may be predicted on historical measurements of the Set B beams where the Set A beams are spatially different than the Set B beams (e.g., the UE 115 may perform spatial and temporal prediction). A trained AI or ML model used for beam prediction may be identified at the network entity 105 and the UE 115 via an associated ID in order to provide consistency between training and inference. In some examples, beam inference may be used in single-cell scenarios.

In some examples, the UE 115 may perform the beam prediction (e.g., temporal beam prediction, spatial beam prediction) using the AI/ML model or functionality in accordance with a set of parameters, such as a Set B beam measurement window length, a Set B beam measurement periodicity, and/or a prediction duration for Set A beams. The UE 115 may report inference parameter sets supported by the UE 115 to the network entity 105. Based on the reported inference parameter sets supported by the UE 115, the network entity 105 may configure CSI reporting configurations (e.g., via RRC signaling) for the UE 115 to measure the Set B beams and to report the predicted measurements. An inference parameter set may become non-applicable at a UE 115 based on changing conditions (e.g., channel or spatial conditions have changed as compared to the channel or spatial conditions used to train the relevant AI/ML model to an extent the AI/ML model may no longer be accurate, or an AI/ML model associated with the inference parameter set may no longer be available at the UE 115). In some examples, the network entity 105 may indicate a correspondence (e.g., mapping information) between CSI reporting configurations and inference parameter sets. For example, by indicating the correspondence (e.g., the mapping) between inference parameter set(s) and a CSI reporting configuration(s), the UE 115 may indicate to the network entity 105 which inference parameter set and/or CSI reporting configurations are applicable and/or non-applicable for CSI reporting in accordance with the indication (e.g., the mapping).

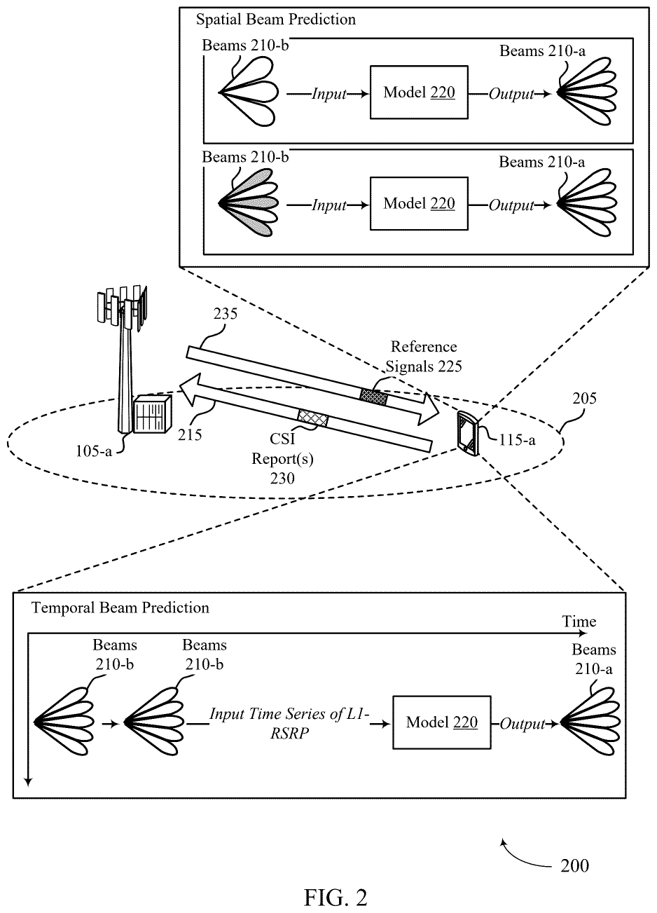

FIG. 2 shows an example of a wireless communications system 200 that supports mapping between inference parameters and CSI reporting configurations in accordance with one or more aspects of the present disclosure. The wireless communications system 200 may include the network entity 105-a, which may be an example of a network entity 105 as described herein. The wireless communications system 200 may include the UE 115-a, which may be an example of a UE 115 as described herein.

In some examples of the wireless communications system 200, a UE 115-a may operate in a cell 205 of the network entity 105-a. The UE 115-a may communicate with the network entity 105-a via one or more channels (e.g., an uplink channel 215, a downlink channel 235).

In some examples, the UE 115-a may use one or more AI/ML models/functionalities (e.g., a model 220) to perform beam prediction. In such examples, the UE 115-a may measure respective beams 210 that correspond to one or more reference signals 225 (e.g., SSBs or CSI-RSs) via a first set of resources, which may be referred to as Set B beams 210-b, during a first set of measurement occasions. Additionally, the UE 115-a may perform beam prediction (e.g., inference, assumption) for a set of beams 210 associated with a second set of resources, which may be referred to as Set A beams 210-a, using the AI/ML model or functionality, which may be based on historical measurement results of the Set B beams 210-b. For example, the UE 115-a may use various measurements of the Set B beams 210-b (e.g., layer 1 (L1) reference signal received powers (RSRPs)) to predict one or more measurements associated with the Set A beams 210-a. In some examples, the UE 115-a may use the AI/ML models or functionalities (e.g., the model 220) based on a training of the AI/ML model or functionality (e.g., based on collected or known data) and one or more inference processes by which the AI/ML model or functionality may use training to analyze additional data and make one or more predictions.

In some examples, the UE 115-a may perform the beam prediction (e.g., temporal beam prediction, spatial beam prediction) using the AI/ML model or functionality in accordance with a set of parameters, including a Set B beam measurement window length, a Set B beam measurement periodicity, and/or a prediction duration for Set A beams. As described herein, spatial beam prediction may refer to the UE 115-a predicting measurements associated with Set A beams 210-a that are different from the measured Set B beams 210-b, and/or Set A beams 210-a that include the Set B beams 210-b and one or more beams that may not be Set B beams 210-b. Temporal beam prediction may refer to the UE 115-a predicting measurements associated with Set A beams 210-a that are the same as the measured Set B beams 210-b, but are transmitted later in time. For example, for temporal beam prediction, the UE 115-a may input a time series of L1-RSRPs associated with the Set B beams 210-b into the model 220 to generate L1-RSRPs associated with the Set A beams 210-a. In some examples, the UE 115-a may send one or more CSI reports 230 that may include the predicted beam measurements (e.g., the predicted measurements for the Set A beams 210-a). In some examples, the UE 115-a may send the one or more CSI reports 230 in accordance with one or more CSI reporting configurations that may be configured for the UE 115-a by the network entity 105-a (e.g., in control signaling such as RRC signaling).

In some examples, the UE 115-a may assume a consistency associated with network-side additional conditions across both training and inference for AI/ML models/functionalities used by the UEs 115-a. The network-side additional conditions may include aspects related to the network entity 105-a that are transparent to one or more UEs 115-a and may impact generalization capabilities of the UEs 115-a. An example of such additional conditions may include a network entity codebook, as some UE-side AI/ML models/functionalities for beam prediction may not generalize well across different network entity codebooks. That is, as described herein, “additional conditions” and “network-side additional conditions” may refer to one or more aspects related to beamforming and/or beam prediction, such as a codebook, and which may be transparent to a UE 115. In some aspects, the “additional conditions” may be referred to as conditions or some other terminology. Consistency associated with network-side additional conditions may enable efficient communications between the UE 115-a and the network entity 105-a.

In some examples, the UE 115-a and the network entity 105-a may use various techniques to support the consistency of network-side conditions across training and inference for UE-sided models for beam management (e.g., where network-side additional conditions may at least impact assumptions of the UE 115-a related to beams 210 of the Set A beams 210-a and the Set B beams 210-b). In some examples, the techniques may be based on an associated ID, where the UE 115-a may assume a consistency of some information for training and inference associated with the same associated ID. As described herein, an “associated ID” may refer to an identifier that is indicative of one or more beam parameters (e.g., beam shapes, beam pointing angles, or other aspects and/or parameters associated with beamforming). The associated ID may, in some examples, be referred to as a data set ID, a data configuration ID, or some similar terminology. In some cases, different infrastructure vendors may use different associated IDs for different beam parameters, which may result in increased processing for the UE 115-a to determine the beam parameters across different vendors. In other examples, the associated IDs may be the same across some vendors.

In some examples, the UE 115-a may predict measurements of the Set A beams 210-a with relatively higher accuracy as a result of receiving additional information (e.g., supplemental information) corresponding to an associated ID, such as information related to relevant beams used for beam prediction and the like. For instance, the UE 115-a may be configured with one or more AI/ML models/functionalities (e.g., the model 220) that are trained using a set of associated IDs (e.g., for beam prediction or other operations). As such, for inference operations, the UE 115-a may identify whether an indicated associated ID for the inference operation corresponds to one of the associated IDs used to train the AI/ML models/functionalities (e.g., the model 220). That is, the UE 115-a may determine to use a particular AI/ML model/functionality that was trained using a same (or similar) associated ID as the associated ID indicated to the UE 115 for beam prediction operations. In some examples, the UE 115-a may use the associated ID within a CSI framework or outside of the CSI framework, among other examples. In some cases, the techniques for performance monitoring may be based on other schemes or parameters. In some examples, for a UE-sided model for beam management, an associated ID configured within a CSI framework may be supported.

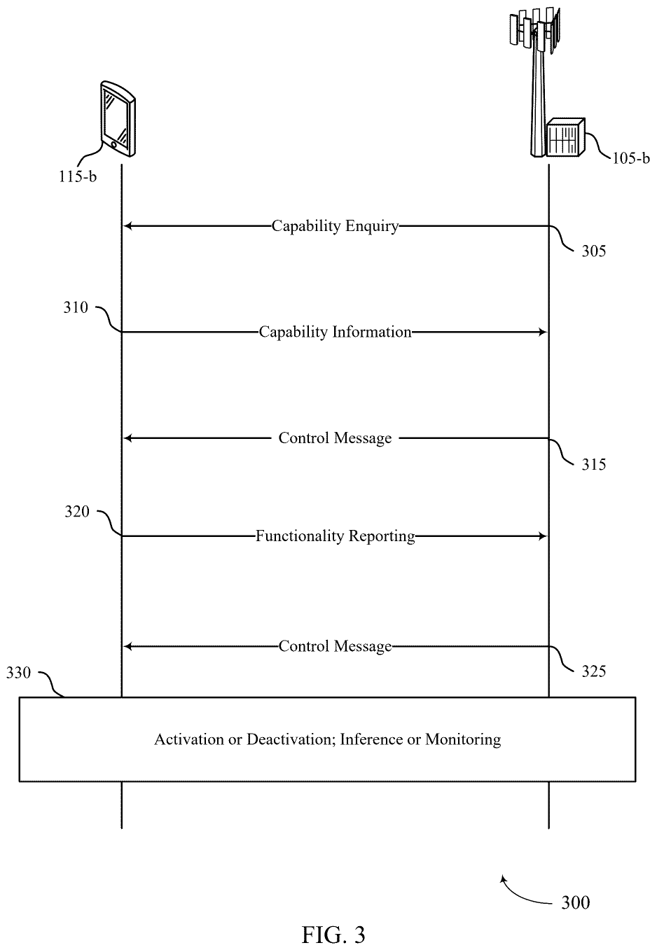

FIG. 3 shows an example of a process flow 300 that supports mapping between inference parameters and CSI reporting configurations in accordance with one or more aspects of the present disclosure. The process flow 300 may implement or may be implemented by aspects of the wireless communications system 100 or the wireless communications system 200. For example, the process flow 300 may illustrate operations between a UE 115-b and network entity 105-b, which may be examples of corresponding devices described herein.

In the following description of the process flow 300, the operations between the UE 115-b and the network entity 105-b may be transmitted in a different order than the example order shown, or the operations performed by the UE 115-b and network entity 105-b may be performed in different orders or at different times. Some operations may also be omitted from the process flow 300, and other operations may be added to the process flow 300. The process flow 300 may be an example of a signaling procedure for applicable functionality reporting for beam management using UE-sided model(s).

At 305, the UE 115-b may receive a capability enquiry message from the network entity 105-b (e.g., a message including an information element (IE) UECapabilityEnquiry) requesting one or more AI/ML-related capabilities of the UE 115-b. As an example, the network entity 105-b may request information regarding AI/ML capabilities of the UE 115-b (e.g., whether the UE 115-b is capable of using AI/ML, one or more functions that the UE 115-b is capable of performing using AI/ML).

At 310, the UE 115-b may transmit capability information (e.g., a message including an IE UECapabilityInformation) to the network entity 105-b. For example, the UE 115-b may provide UE capability parameters associated with one or more feature groups for AI/ML operations/functions. In some cases, the UE 115-b may indicate a set of feature groups and/or a set of parameters within each feature group (e.g., within each functionality). The UE 115-b may transmit the capability information in response to the capability enquiry message.

At 315, the network entity 105-b may transmit, to the UE 115-b, a control message including (or indicating) one or more sets of beam inference information (e.g., combinations of associated IDs and configurations for inference operations and/or parameters associated with the inference operations) corresponding to current network-side additional conditions of the network entity 105-b, future additional conditions of the network entity 105-b, and/or additional conditions associated with one or more other network entities 105. In some examples, the control message may be an RRC reconfiguration message (e.g., an RRCReconfiguation message) that includes (or indicates) the one or more sets of inference information.

For example, the network entity 105-b may indicate one or more CSI reporting configurations (e.g., one or more IE CSI-ReportConfigs) that may be used for the purpose of enabling inference operation for beam prediction and/or the one or more parameters. In some examples, the one or more configurations and/or the one or more parameters may include the associated ID for a AI/ML model. In some cases, the network entity 105-b may provide one or more other configurations to the UE 115-b. The one or more other configurations may include, for example, whether the UE 115-b is enabled (e.g., allowed) to perform uplink assistance information (UAI) reporting via OtherConfig, whether the network entity 105-b may provide network-side additional conditions (e.g., conditions which may be signaled via RRC signaling, and may be mandatory or optional), and/or one or more configurations (e.g., inference configurations) of supported functionalities.

In some examples, after 315 (e.g., and before 320), the UE 115-b may determine (e.g., identify, select) the applicable functionalities (e.g., inference parameter sets) based on the network-side additional conditions (e.g., if provided), one or more UE-side additional conditions (e.g., internally known by the UE 115-b), and/or model availability in the UE 115-b. In some examples one or more other configurations may be considered by the UE 115-b (e.g., inference configuration), and the UE 115-b may, in some cases, be capable of determining the applicable functionality when network-side additional conditions are not provided at 315.

At 320, the UE 115-b may report applicable functionality e.g., inference parameter set(s)) to the network entity 105-b. In some examples, the applicable functionality may be reported at or after configuration of the UE 115-b to provide applicable functionality, after a change of applicable functionality via UAI, as a response to network-side additional condition requesting applicable functionality reporting. via other network configuration (e.g., inference configuration), via UAI, or via an RRC reconfiguration complete message (e.g., an RRCReconfigurationComplete message).

At 325, the network entity 105-b may configure (e.g., via a control message, such as an RRCReconfiguration message) one or more inference configurations for the UE 115-b after the applicable functionality reporting. For example, in examples in which an inference configuration based on supported functionality is not provided at 305, the network entity 105-b may provide the inference configuration at 325. Additionally, or alternatively, at 325, if one or more inference configurations based on supported functionality are provided at 315, the network entity 105-b may determine whether to provide an updated configuration.

At 330, the UE 115-b and/or the network entity 105-b may activate or deactivate one or more AI/ML models/functionalities, and/or the UE 115-b and/or network entity 105-b may perform inference using the AI/ML models/functionalities. Additionally, or alternatively, the UE 115-b and/or the network entity 105-b may perform monitoring procedures in accordance with the configured CSI reporting configurations (e.g., in accordance with the one or more CSI-ReportConfigs configured in the RRCReconfiguration message at 325).

In some examples, there may be various options associated with the signaling of applicability for inference in accordance with a UE-side model for beam prediction. For example, the network entity 105-b may configure the UE 115-b with one or more configurations for inference (e.g., one or more CSI-ReportConfigs). In such examples, the associated ID may be configured in a CSI framework. For instance, in accordance with a first option, at 315, one or more configurations may be provided from the network entity 105-b to the UE 115-b. In a first example, the UE 115-b may be enabled to perform UAI reporting (e.g., via a parameter OtherConfig). In some examples, an applicability report may be based on one or more CSI reporting configurations (e.g., CSI-ReportConfigs) for inference configurations (where the associated ID may be configured in the CSI framework as a working assumption applied). In such examples, a CSI reporting configuration for a UE-side model inference may not be activated immediately at 315. In a second option, an applicability report may be based on one set or multiple sets of inference parameters for the applicability report (e.g., not for inference). The set of inference parameters for the applicability report may be selected from the IEs in or the IEs referred by the CSI-ReportConfig. For example, such inference parameters may include the associated ID, Set A related information, Set B related information, report content related information, time instances related information for measurements (e.g., for beam management case 2), and/or time instances related information for predictions (e.g., for beam management case 2). At 320, the UE 115-b may report the applicability in accordance with the first option (e.g., for the one or more CSI-ReportConfigs) or the second option (e.g., for the set(s) of inference parameters).

If the first option is used, applicable aperiodic CSI reports and semi-persistent CSI reports may be activated/triggered by the network entity 105-b after the applicability is reported. In some examples, if the first option is used, an applicable periodic CSI report may be considered as activated only if the applicability of the corresponding CSI-ReportConfig is reported in RRCReconfigurationComplete.

In some examples, at 325, the network entity 105-b may optionally configure (e.g., if the UE 115-b has already been configured with a CSI-ReportConfig at 315) a CSI-ReportConfig for inference configuration in an RRCReconfiguration message, where the associated ID may be configured in CSI framework as a working assumption applied. For beam management, multiple CSI reports for inference for UE-side model can be configured/activated/triggered, which may be up to the capability of the UE 115-b.

As described herein, for the CSI-ReportConfig for inference configuration provided at 325, aperiodic CSI Report and semi-persistent CSI report may be activated/triggered by the network entity 105-b after RRCReconfigurationComplete, and a periodic CSI Report may be considered as activated after RRCReconfigurationComplete. The UE 115-b may not expect to be configured with a CSI-ReportConfig for inference configuration for a non-applicable set of inference parameters or a non-applicable CSI-ReportConfig.

To determine applicability at the UE 115-b, the UE 115-b may be configured with inference parameter sets and/or CSI reporting configurations (e.g., CSI-ReportConfigs) at 315. The UE 115-a may report identifiers of applicable inference parameter sets and/or CSI reporting configurations at 320. If the UE 115-b is configured with inference parameter sets at 315, then at 325 the UE 115-b may be configured with or CSI reporting configurations (e.g., CSI-ReportConfigs). For example, the UE 115-b may be configured with aperiodic CSI report(s) and semi-persistent CSI report(s) which can be activated/triggered by the network entity 105-b after RRCReconfigurationComplete. As another example, the UE 115-b may be configured with periodic CSI Report(s) which may be considered as activated after RRCReconfigurationComplete. If the UE 115-b is configured with CSI reporting configurations (e.g., CSI-ReportConfigs) at 315, the network entity 105-b may optionally update the CSI reporting configurations at 325. In such examples, applicable aperiodic CSI report(s) and semi-persistent CSI report(s) may be activated/triggered by the network entity 105-b after the applicability is reported by the UE 115-b at 320, and applicable periodic CSI report(s) may be considered as activated if the applicability of the corresponding CSI-ReportConfig is reported in RRCReconfigurationComplete.

In some examples, the UE 115-b may be configured with one or more inference parameter sets at 315 and may be configured with one or more CSI reporting configurations (e.g., CSI-ReportConfigs) at 325. In such examples, the network entity 105-b may indicate (e.g., via control signaling) a correspondence between the one or more inference parameter sets and the one or more CSI reporting configurations. For example, the UE 115-b may be provided (e.g., at 325) with control signaling that indicates mapping information (e.g., a mapping configuration, one or more mapping configurations) between the one or more inference parameter sets and the one or more CSI reporting configurations to simplify UE processing and/or applicability reporting procedures. In an example, a first mapping (e.g., a first mapping configuration) may be a one-to-one mapping, where a single CSI reporting configuration is provided for a single applicable inference parameter set (e.g., each applicable inference parameter set may be mapped to up to one CSI reporting configuration). As another example, a second mapping may be a one-to-multiple mapping where more than one CSI reporting configuration may be provided for an applicable inference parameter set (e.g., each applicable inference parameter set may be mapped to multiple CSI reporting configurations). As another example, a third mapping may be a multiple-to-multiple mapping where more than one CSI reporting configuration may be provided for an applicable inference parameter set and more than one applicable inference parameter set may be mapped to a CSI reporting configuration. In a multiple-to-multiple mapping, the network entity 105-b may configure multiple inference parameter sets to in order for the UE 115-b to determine a single CSI reporting configuration.

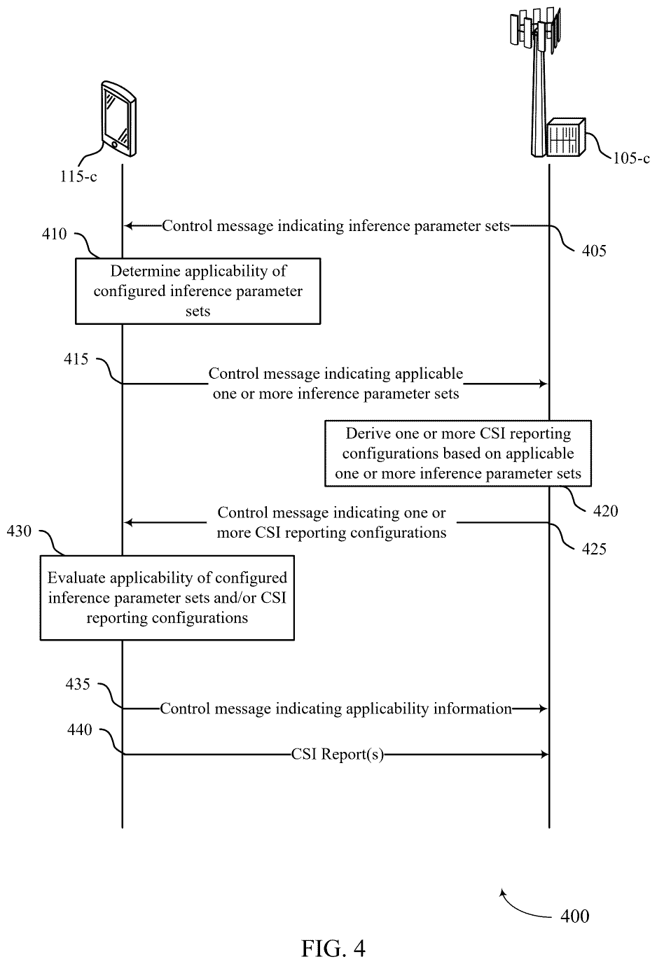

FIG. 4 shows an example of a process flow 400 that supports mapping between inference parameters and CSI reporting configurations in accordance with one or more aspects of the present disclosure. The process flow 400 may implement or may be implemented by aspects of the wireless communications system 100, the wireless communications system 200, or the process flow 300. For example, the process flow 400 may illustrate operations between a UE 115-c and network entity 105-c, which may be examples of corresponding devices described herein.

In the following description of the process flow 400, the operations between the UE 115-c and the network entity 105-c may be transmitted in a different order than the example order shown, or the operations performed by the UE 115-c and the network entity 105-c may be performed in different orders or at different times. Some operations may also be omitted from the process flow 400, and other operations may be added to the process flow 400.

In some examples, at 405, the network entity 105-c may transmit, and the UE 115-c may receive, a control message that configures one or more inference parameter sets. For example, the control message at 405 may correspond to the control message at 315 as described with reference to FIG. 3 (e.g., the network entity 105-c may transmit the control message at 405 after the UE 115-c transmits capability information to the network entity 105-c that indicates supported AI/ML operations/functions).

In some examples, at 410, the UE 115-c may determine the applicability of the one or more inference parameter sets configured by the control message at 405. For example, as described herein, the UE 115-c may determine the applicability of the one or more inference parameter sets based on the network-side additional conditions (e.g., if provided), one or more UE-side additional conditions (e.g., internally known by the UE 115-c), and/or AI/ML model availability at the UE 115-c.

At 415, the UE 115-c may transmit a control message (e.g., a first control message) to the network entity 105-c that may indicate the supported or applicable one or more inference parameter sets based on the determination at 410. For example, the control message at 415 may correspond to the control message at 320 as described with reference to FIG. 3.

In some examples, at 420, the network entity 105-c may derive one or more CSI reporting configurations (e.g., one or more CSI-ReportConfigs) based on the one or more supported or applicable inference parameter sets reported in the control message at 415.

At 425, the network entity 105-c may transmit, and the UE 115-c may receive, a control message (e.g., a second control message) that configures inference parameter set(s) and/or one or more CSI reporting configurations based on one or more applicable inference parameter sets reported by the UE at 415. The control message at 425 may include an indication that an inference parameter set of the one or more inference parameter sets corresponds to the one or more CSI reporting configurations (e.g., at least one CSI reporting configuration). For example, the control message may further indicate a mapping configuration that maps at least one inference parameter set of the one or more inference parameter sets indicated as being applicable or supported in the control message at 415 and one or more CSI reporting configurations (e.g., maps the at least one inference parameter set to one or more CSI reporting configurations). For example, the control message at 425 may correspond to the control message at 325 as described with reference to FIG. 3. For example, the control message at 425 may be an RRCReconfiguration message.

In some examples, the UE 115-c may transmit one or more additional control messages (e.g., one or more third control messages) to the network entity 105-c. The one or more additional control messages may indicate whether the inference parameter set is applicable or non-applicable for CSI reporting based on the control information at 425 (e.g., the second control information, the mapping configuration). For example, the one or more additional control messages may be applicability signaling (e.g., at 435) indicating the applicability of the CSI reporting configurations and/or the one or more inference parameter sets indicated as being applicable or supported (e.g., for CSI reporting) in the control message at 415. As another example, the one or more additional control messages may be CSI reports at 440 in accordance with the applicable CSI reporting configurations.

In some examples, at 430, the UE 115-c may evaluate the applicability of the configured at least one inference parameter set and/or one or more CSI reporting configurations in accordance with the second control information (e.g., the mapping configuration).

In some examples, at 435 the UE 115-c may transmit a control message that may indicate applicability information for at least one inference parameter set and/or one or more CSI reporting configurations in accordance with the second control information (e.g., the mapping configuration) and based on the evaluation at 430.

In some examples, at 440, the UE 115-c may transmit one or more CSI reports in accordance with the applicable one or more CSI reporting configurations. The one or more CSI reports may include predicted beam measurement results generated in accordance with the applicable one or more CSI reporting configurations.

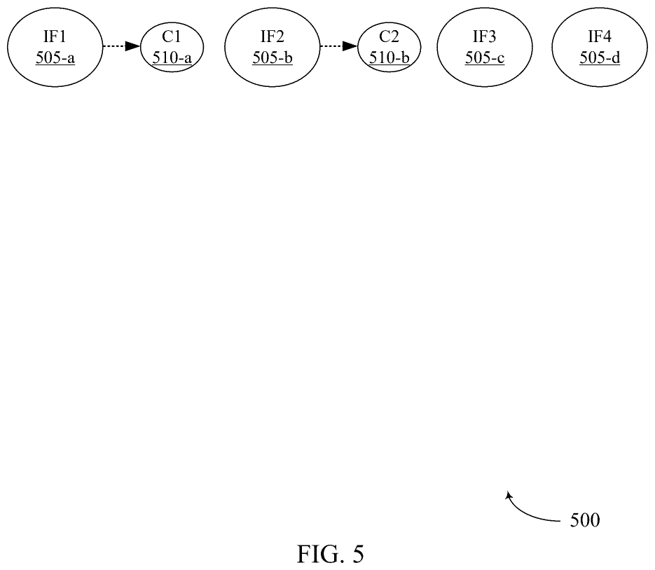

In some examples, the second control information (e.g., the mapping configuration) may indicate a one-to-one correspondence (e.g., a one-to-one mapping), for example, as described with reference to FIG. 5. A one-to-one mapping may imply that when an applicable inference parameter set becomes non-applicable, the single corresponding CSI reporting configuration becomes non-applicable, and vice versa. In a one-to-one mapping, the UE 115-c may determine applicability of a given CSI reporting configuration based on the applicability of the mapped inference parameter set, which may demand inference parameters to be similar to the inference configuration of the mapped CSI reporting configuration.

In some examples, for a one-to-one mapping, in a first option, the UE 115-c may be configured to evaluate inference parameter sets and not to evaluate the CSI reporting configurations at 430. For example, in the first option, the UE 115-c may not demand an indication of the mapping between inference parameter sets and CSI reporting configurations. For example, the network entity 105-c may activate/reactivate/reconfigure/deactivate CSI report configurations based on reported applicabilities of the inference parameter sets in the control message at 435. In a second option, the UE 115-c may evaluate, at 430: 1) the applicable inference parameter sets (e.g., the inference parameter sets mapped to CSI reporting configurations in the control message at 425); 2) non-applicable inference parameter sets (e.g., any other inference parameter reports indicated as being supported in the control message at 415 which were not mapped to CSI reporting configurations in the control message at 425); and 3) the CSI reporting configurations configured for the UE 115-c in the control message at 425. For example, in the second option, with reference to FIG. 5, the UE 115-c may evaluate the applicability of IF1 505-a, IF2 505-b, IF3 505-c, IF4 505-d, CI1 510-a, and CI2 510-b. In FIG. 5-7, “IF” refers to an inference parameter set, and “CI” refers to a CSI reporting configuration. The UE 115-c may report evaluated applicabilities and/or non-applicabilities of the inference parameter sets and the CSI reporting configurations in the control message at 435.

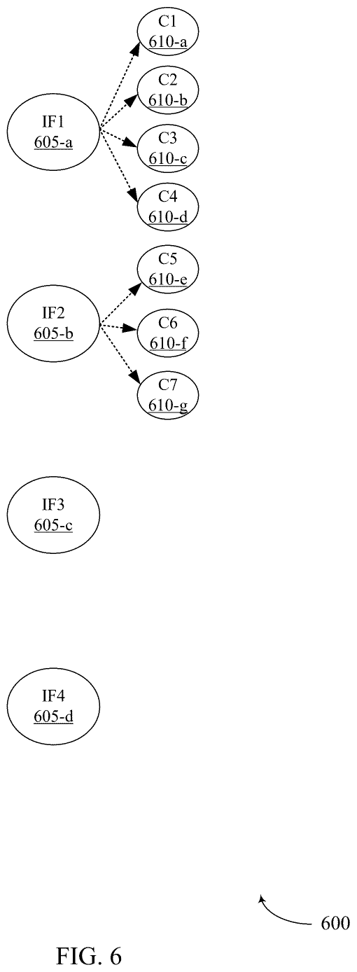

In some examples, the second control information (e.g., the mapping configuration) may indicate a one-to-multiple mapping, for example, as described with reference to FIG. 6. A one-to-multiple mapping may imply that when an applicable inference parameter set becomes non-applicable, the one or more corresponding CSI reporting configurations mapped to the applicable inference parameter set also become non-applicable. If a CSI reporting configuration mapped to an applicable inference parameter set in accordance with a one-to-multiple mapping becomes non-applicable, however, the inference parameter set may not become non-applicable if the inference parameter set is mapped to one or more other CSI reporting configurations that are still applicable.

In a one-to-multiple mapping, in a first option, the UE 115-c may be configured to evaluate at 435: 1) the applicable inference parameter sets (e.g., the inference parameter sets mapped to CSI reporting configurations in the control message at 425); 2) non-applicable inference parameter sets (e.g., any other inference parameter reports indicated as being supported in the control message at 415 which were not mapped to CSI reporting configurations in the control message at 425); and 3) the CSI reporting configurations configured for the UE 115-c in the control message at 425. For example, in the first option, with reference to FIG. 6, the UE 115-c may evaluate the applicability of IF1 605-a, IF2 605-b, IF3 605-c, IF4 605-d, C1 610-a, C2 610-b, C3 610-c, C4 610-d, C5 610-e, C6 610-f, and C7 610-g. In a second option, the UE 115-c may be configured to evaluate at 435: 1) non-applicable inference parameter sets (e.g., any other beam inference parameter reports indicated as being supported in the control message at 415 which were not mapped to CSI reporting configurations in the control message at 425); and 2) the CSI reporting configurations configured for the UE 115-c in the control message at 425. For example, in the second option, with reference to FIG. 6, the UE 115-c may evaluate the applicability of IF3 605-c, IF4 605-d, C1 610-a, C2 610-b, C3 610-c, C4 610-d, C5 610-e, C6 610-f, and C7 610-g.

In a one-to-multiple mapping, if an inference parameter set becomes non-applicable, the UE 115-c may indicate, in the control message at 435, an ID of the inference parameter set. In the response, the network may deactivate all CSI report configurations derived based on reported non-applicable ID of inference parameter set(s). The UE 115-c may indicate, in the control message at 435, the ID(s) of one or more CSI reporting configurations if the CSI reporting configurations become non-applicable but the mapped inference parameter set is still applicable. In the response, the network may deactivate only non-applicable CSI report configuration(s).

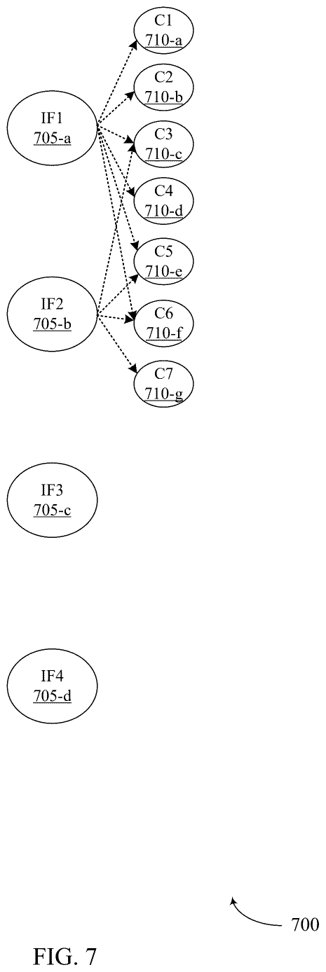

In some examples, the second control information (e.g., the mapping configuration) may indicate a multiple-to-multiple mapping, for example, as described with reference to FIG. 7. If a CSI reporting configuration mapped to an applicable inference parameter set in accordance with a multiple-to-multiple mapping becomes non-applicable, the inference parameter set may not become non-applicable if the inference parameter set is mapped to one or more other CSI reporting configurations that are applicable. Similarly, an inference parameter set mapped to a CSI reporting configuration in accordance with a multiple-to-multiple mapping becomes non-applicable, the CSI reporting configuration may not become non-applicable if the CSI reporting configuration set is mapped to one or more other bam inference parameter sets that are applicable.

In a multiple-to-multiple mapping, in a first option, the UE 115-c may be configured to evaluate at 435: 1) the applicable inference parameter sets (e.g., the inference parameter sets mapped to CSI reporting configurations in the control message at 425); 2) non-applicable inference parameter sets (e.g., any other inference parameter reports indicated as being supported in the control message at 415 which were not mapped to CSI reporting configurations in the control message at 425); and 3) the CSI reporting configurations configured for the UE 115-c in the control message at 425. For example, in the first option, with reference to FIG. 7, the UE 115-c may evaluate the applicability of IF1 705-a, IF2 705-b, IF3 705-c, IF4 705-d, C1 710-a, C2 710-b, C3 710-c, C4 710-d, C5 710-e, C6 710-f, and C7 710-g. In a second option, the UE 115-c may be configured to evaluate at 435: 1) non-applicable inference parameter sets (e.g., any other inference parameter reports indicated as being supported in the control message at 415 which were not mapped to CSI reporting configurations in the control message at 425); and 2) the CSI reporting configurations configured for the UE 115-c in the control message at 425. For example, in the second option, with reference to FIG. 7, the UE 115-c may evaluate the applicability of IF3 705-c, IF4 705-d, C1 610-a, C2 710-b, C3 710-c, C4 710-d, C5 710-e, C6 710-f, and C7 710-g.

In a multiple-to-multiple mapping, if an inference parameter set becomes non-applicable, the UE 115-c may indicate, in the control message at 435, an ID of the inference parameter set. In the multiple-to-multiple mapping, even if the inference parameter set becomes non-applicable, the CSI report configuration may still remain applicable. For example, if IF1 705-a becomes non-applicable, this implies that C1 710-a, C2 710-b, and C4 710-d have become non-applicable, but C3 710-c, C5 710-e, and C6 710-f may still remain applicable. Thus, the network may signal IDs of individual CSI report configuration for deactivation of inference operations at the UE. The UE 115-c may indicate, in the control message at 435, the ID(s) of one or more CSI reporting configurations if the CSI reporting configurations become non-applicable. In the response, the network may deactivate only non-applicable CSI report configurations.

In a one-to-multiple mapping or a multiple-to-multiple mapping, the UE 115-c may consider an inference parameter set applicable if the UE 115-c has an AI/ML model available for the one or more relevant CSI resources or resource set relevant to the inference parameter set for the cell (serving cell or cell IDs indicated at 405 to the UE 115-c for determining the applicability of inference related parameter set). In some examples, however, the network entity 105-c may provide a CSI reporting configuration that the UE 115-c may not have considered for determining the applicability of the inference parameter set. Thus, the UE 115-c may determine (e.g., and signal in the control message at 435) if the one or more CSI reporting configurations are applicable.

FIG. 5 shows an example of an inference parameter set to CSI reporting configuration mapping diagram 500 that supports mapping between inference parameters and CSI reporting configurations in accordance with one or more aspects of the present disclosure. The inference parameter set to CSI reporting configuration mapping diagram 500 may implement aspects of or may be implemented by aspects of the wireless communications system 100, the wireless communications system 200, the process flow 300, or the process flow 400. For example, the inference parameter to CSI reporting configuration mapping diagram 500 shows a mapping of inference parameter sets (shown as IFs 505) and CSI reporting configurations (shown as CIs 510) which may be indicated in a control message at 425 as described with reference to FIG. 4.

The inference parameter set to CSI reporting configuration mapping diagram 500 shows an example of a one-to-one mapping between IFs 505 and CIs 510. For example, as described with reference to FIG. 4, a UE 115 may send a control message (e.g., at 415) indicating applicable or supported IFs 505 (e.g., the IF1 505-a, the IF2 505-b, the IF3 505-c, and the IF4 505-d). The network entity 105 may send a control message (e.g., at 425) which may configure the CIs 510 (e.g., the CI1 510-a and the CI2 510-b) and/or may indicate that the IF1 505-a is mapped to the CI 1 510-a and that the IF2 505-b is mapped to the CI 2 510-b.

FIG. 6 shows an example of an inference parameter set to CSI reporting configuration mapping diagram 600 that supports mapping between inference parameters and CSI reporting configurations in accordance with one or more aspects of the present disclosure. The inference parameter set to CSI reporting configuration mapping diagram 600 may implement aspects of or may be implemented by aspects of the wireless communications system 100, the wireless communications system 200, the process flow 300, or the process flow 400. For example, the inference parameter to CSI reporting configuration mapping diagram 600 shows a mapping of inference parameter sets (shown as IFs 605) and CSI reporting configurations (shown as CIs 610) which may be indicated in a control message at 425 as described with reference to FIG. 4.

The inference parameter set to CSI reporting configuration mapping diagram 600 shows an example of a one-to-multiple mapping between IFs 605 and CIs 610. For example, as described with reference to FIG. 4, a UE 115 may send a control message (e.g., at 415) indicating applicable or supported IFs 605 (e.g., the IF1 605-a, the IF2 605-b, the IF3 605-c, and the IF4 605-d). The network entity 105 may send a control message (e.g., at 425) which may configure the CIs 610 (e.g., the CI 610-a, the CI2 610-b, the CI3 610-c, the CI4 610-d, the CI5 610-e, the CI6 610-f, and the CI7 610-g). The control message that configures the CIs 610 may indicate that the IF1 605-a is mapped to the CI1 610-a, the CI2 610-b, the CI3 610-c, and the CI4 610-d, and that the IF2 605-b is mapped to the CI5 610-e, the CI6 610-f, and the CI7 610-g.

FIG. 7 shows an example of an inference parameter set to CSI reporting configuration mapping diagram 700 that supports mapping between inference parameters and CSI reporting configurations in accordance with one or more aspects of the present disclosure. The inference parameter set to CSI reporting configuration mapping diagram 700 may implement aspects of or may be implemented by aspects of the wireless communications system 100, the wireless communications system 200, the process flow 300, or the process flow 400. For example, the inference parameter to CSI reporting configuration mapping diagram 700 shows a mapping of inference parameter sets (shown as IFs 705) and CSI reporting configurations (shown as CIs 710) which may be indicated in a control message at 425 as described with reference to FIG. 4.

The inference parameter set to CSI reporting configuration mapping diagram 700 shows an example of a multiple-to-multiple mapping between IFs 705 and CIs 710. For example, as described with reference to FIG. 4, a UE 115 may send a control message (e.g., at 415) indicating applicable or supported IFs 705 (e.g., the IF1 705-a, the IF2 705-b, the IF3 705-c, and the IF4 705-d). The network entity 105 may send a control message (e.g., at 425) which may configure the CIs 710 (e.g., the CI1 710-a, the CI2 710-b, the CI3 710-c, the CI4 710-d, the CI5 710-e, the CI6 710-f, and the CI7 710-g). The control message that configures the CIs 710 may indicate that the IF1 705-a is mapped to the CI1 710-a, the CI2 710-b, the CI3 710-c, the CI4 710-d, and the CI6 710-f, and that the IF2 705-b is mapped to the CI3 710-c, CI5 710-e, the CI6 710-f, and the CI7 710-g.

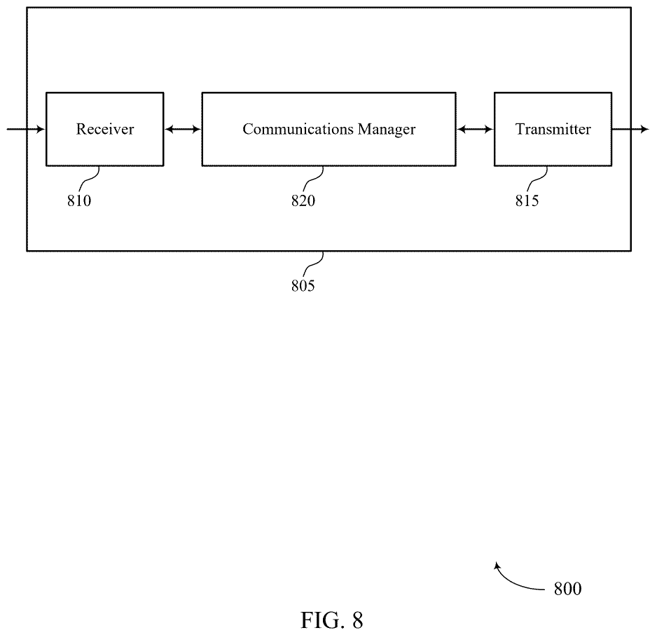

FIG. 8 shows a block diagram 800 of a device 805 that supports mapping between inference parameters and CSI reporting configurations in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to mapping between inference parameters and CSI reporting configurations). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to mapping between inference parameters and CSI reporting configurations). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of mapping between inference parameters and CSI reporting configurations as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a first control message that indicates a set of multiple inference parameter sets supported by the UE. The communications manager 820 is capable of, configured to, or operable to support a means for receiving, based on the first control message, a second control message including an indication that indicates a (e.g., indicates a mapping configuration that maps) an inference parameter set of the set of multiple inference parameter sets corresponds to one or more CSI reporting configurations. The communications manager 820 is capable of, configured to, or operable to support a means for transmitting one or more third control messages, where the one or more third control messages indicate whether the inference parameter set is applicable or non-applicable for CSI reporting based on the second control information (e.g., the mapping configuration).

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for determining and/or reporting applicable and non-applicable inference parameter sets and/or CSI reporting configurations, which may support reduced processing, reduced power consumption, and more efficient utilization of communication resources.

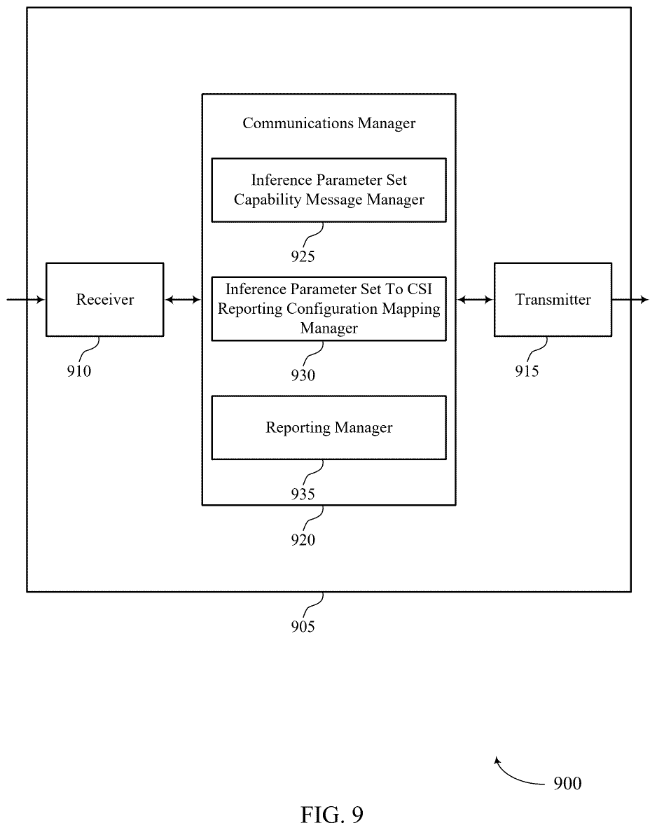

FIG. 9 shows a block diagram 900 of a device 905 that supports mapping between inference parameters and CSI reporting configurations in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to mapping between inference parameters and CSI reporting configurations). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to mapping between inference parameters and CSI reporting configurations). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of mapping between inference parameters and CSI reporting configurations as described herein. For example, the communications manager 920 may include an inference parameter set capability message manager 925, an inference parameter set to CSI reporting configuration mapping manager 930, a reporting manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The inference parameter set capability message manager 925 is capable of, configured to, or operable to support a means for transmitting a first control message that indicates a set of multiple inference parameter sets supported by the UE. The inference parameter set to CSI reporting configuration mapping manager 930 is capable of, configured to, or operable to support a means for receiving, based on the first control message, a second control message indicating that an inference parameter set of the set of multiple inference parameter sets corresponds to one or more CSI reporting configurations. The reporting manager 935 is capable of, configured to, or operable to support a means for transmitting one or more third control messages, where the one or more third control messages indicate whether the inference parameter set is applicable or non-applicable for CSI reporting based on the second control information.

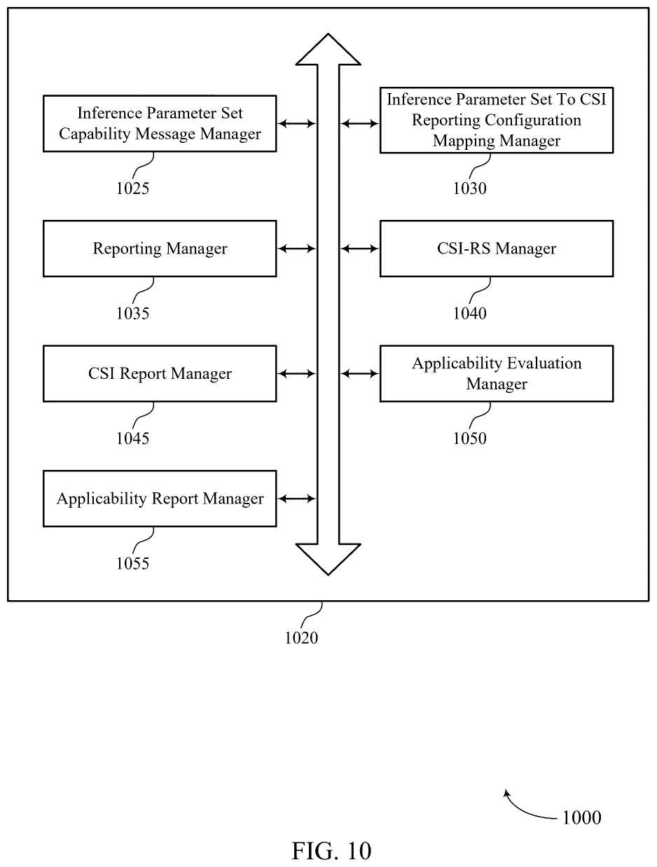

FIG. 10 shows a block diagram 1000 of a communications manager 1020 that supports mapping between inference parameters and CSI reporting configurations in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of mapping between inference parameters and CSI reporting configurations as described herein. For example, the communications manager 1020 may include an inference parameter set capability message manager 1025, an inference parameter set to CSI reporting configuration mapping manager 1030, a reporting manager 1035, a CSI-RS manager 1040, a CSI report manager 1045, an applicability evaluation manager 1050, an applicability report manager 1055, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The inference parameter set capability message manager 1025 is capable of, configured to, or operable to support a means for transmitting a first control message that indicates a set of multiple inference parameter sets supported by the UE. The inference parameter set to CSI reporting configuration mapping manager 1030 is capable of, configured to, or operable to support a means for receiving, based on the first control message, a second control message including an indication that an inference parameter set of the set of multiple inference parameter sets corresponds to one or more CSI reporting configurations. The reporting manager 1035 is capable of, configured to, or operable to support a means for transmitting one or more third control messages, where the one or more third control messages indicate whether the inference parameter set is applicable or non-applicable for CSI reporting based on the second control information.

In some examples, the second control information indicates that a first inference parameter set of the set of multiple inference parameter sets is one-to-one mapped to a first CSI reporting configuration of the one or more CSI reporting configurations.

In some examples, the second control information indicates that a second inference parameter set of the set of multiple inference parameter sets is one-to-one mapped to a second CSI reporting configuration of the one or more CSI reporting configurations.

In some examples, to support transmitting the one or more third control messages, the applicability report manager 1055 is capable of, configured to, or operable to support a means for transmitting, after reception of the second control message, a third control message indicating that the first inference parameter set is applicable or non-applicable for CSI reporting.

In some examples, the applicability evaluation manager 1050 is capable of, configured to, or operable to support a means for evaluating, after reception of the second control message, respective applicability statuses for the first inference parameter set, the first CSI reporting configuration, the second inference parameter set, the second CSI reporting configuration, and a third inference parameter set of the set of multiple inference parameter sets.

In some examples, to support transmitting the one or more third control messages, the applicability report manager 1055 is capable of, configured to, or operable to support a means for transmitting a third control message indicating that the first inference parameter set is applicable or non-applicable for CSI reporting based on the first inference parameter set or the first CSI reporting configuration becoming applicable or non-applicable for CSI reporting at the UE in accordance with the evaluating.

In some examples, the second control information indicates that the inference parameter set is mapped to a set of multiple CSI reporting configurations.

In some examples, the second control information indicates that a second inference parameter set of the set of multiple inference parameter sets is mapped to a second set of multiple CSI reporting configurations.

In some examples, the applicability evaluation manager 1050 is capable of, configured to, or operable to support a means for evaluating, after reception of the second control message, respective applicability statuses for the inference parameter set, the set of multiple CSI reporting configurations, the second inference parameter set, the second set of multiple CSI reporting configurations, and a third inference parameter set of the set of multiple inference parameter sets.

In some examples, to support transmitting the one or more third control messages, the applicability report manager 1055 is capable of, configured to, or operable to support a means for transmitting a third control message indicating that the inference parameter set has become applicable or non-applicable for CSI reporting at the UE in accordance with the evaluating.

In some examples, to support transmitting the one or more third control messages, the applicability report manager 1055 is capable of, configured to, or operable to support a means for transmitting a third control message indicating that at least one CSI reporting configuration of the set of multiple CSI reporting configurations have become applicable or non-applicable for CSI reporting at the UE in accordance with the evaluating.

In some examples, the second control information indicates the inference parameter set is mapped to a set of multiple CSI reporting configurations and that each of the set of multiple CSI reporting configurations is mapped to multiple inference parameter sets of the set of multiple inference parameter sets.

In some examples, the applicability evaluation manager 1050 is capable of, configured to, or operable to support a means for evaluating, after reception of the second control message, respective applicability statuses for the set of multiple CSI reporting configurations, the multiple inference parameter sets, and a second inference parameter set of the set of multiple inference parameter sets.

In some examples, to support transmitting the one or more third control messages, the applicability report manager 1055 is capable of, configured to, or operable to support a means for transmitting a third control message indicating that the inference parameter set has become applicable or non-applicable for CSI reporting at the UE in accordance with the evaluating.

In some examples, to support transmitting the one or more third control messages, the applicability report manager 1055 is capable of, configured to, or operable to support a means for transmitting a third control message indicating that at least one CSI reporting configuration of the set of multiple CSI reporting configurations has become applicable or non-applicable for CSI reporting at the UE in accordance with the evaluating.

In some examples, the CSI-RS manager 1040 is capable of, configured to, or operable to support a means for receiving one or more reference signals in accordance with the one or more CSI reporting configurations. In some examples, the CSI report manager 1045 is capable of, configured to, or operable to support a means for transmitting one or more CSI reports in accordance with the one or more CSI reporting configurations, where the one or more CSI reports include predicted beam measurement values based on the one or more reference signals in accordance with the inference parameter set.

In some examples, the second control information indicates a mapping configuration that maps the inference parameter set of the one or more inference parameter sets to the one or more CSI reporting configurations.

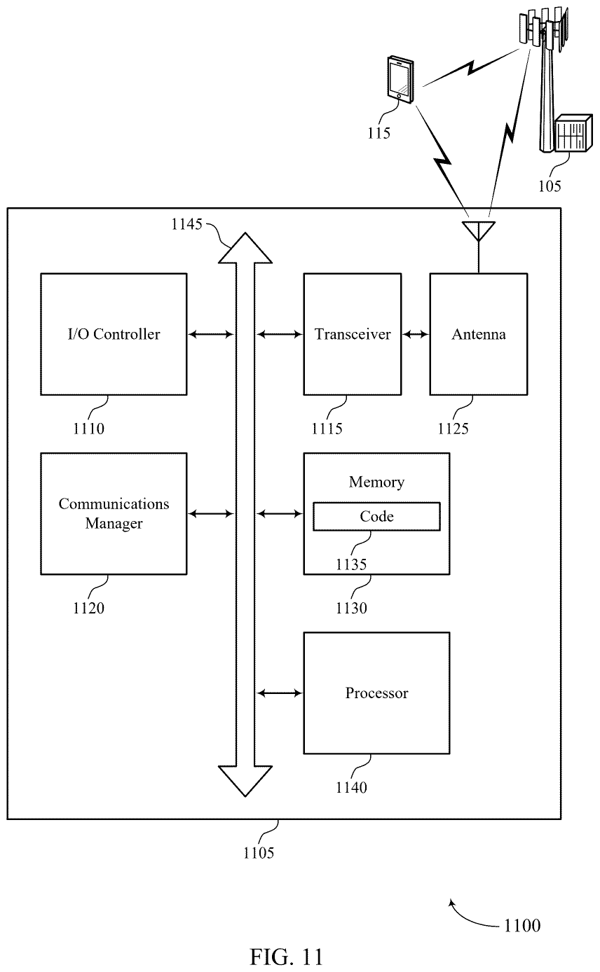

FIG. 11 shows a diagram of a system 1100 including a device 1105 that supports mapping between inference parameters and CSI reporting configurations in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting mapping between inference parameters and CSI reporting configurations). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting a first control message that indicates a set of multiple inference parameter sets supported by the UE. The communications manager 1120 is capable of, configured to, or operable to support a means for receiving, based on the first control message, a second control message including an indication that an inference parameter set of the set of multiple inference parameter sets corresponds to one or more CSI reporting configurations. The communications manager 1120 is capable of, configured to, or operable to support a means for transmitting one or more third control messages, where the one or more third control messages indicate whether the inference parameter set is applicable or non-applicable for CSI reporting based on the second control information.

By including or configuring the communications manager 1120 in accordance with examples as described herein, the device 1105 may support techniques for determining and/or reporting applicable and non-applicable inference parameter sets and/or CSI reporting configurations, which may support reduced power consumption, more efficient utilization of communication resources, improved coordination between devices, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of mapping between inference parameters and CSI reporting configurations as described herein, or the at least one processor 1140 and the at least one memory 1130 may be otherwise configured to, individually or collectively, perform or support such operations.

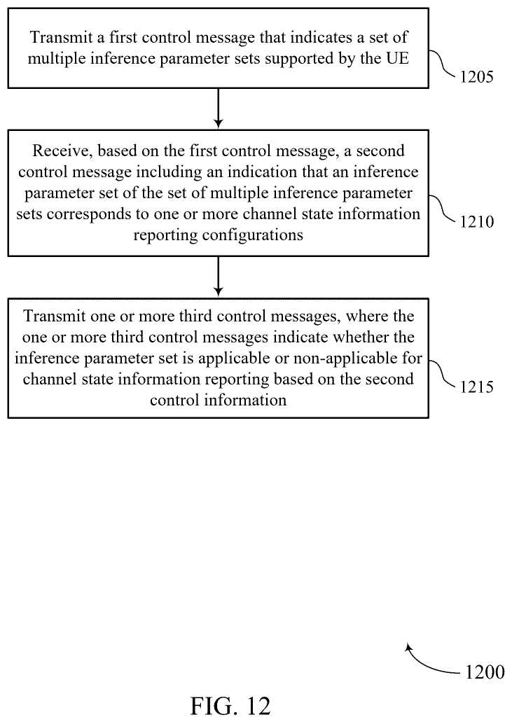

FIG. 12 shows a flowchart illustrating a method 1200 that supports mapping between inference parameters and CSI reporting configurations in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include transmitting a first control message that indicates a set of multiple inference parameter sets supported by the UE. The operations of 1205 may be performed in accordance with examples as disclosed herein. In some examples, aspects of the operations of 1205 may be performed by an inference parameter set capability message manager 1025 as described with reference to FIG. 10.

At 1210, the method may include receiving, based on the first control message, a second control message including an indication that (e.g., indicates a mapping configuration that maps) an inference parameter set of the set of multiple inference parameter sets corresponds to one or more CSI reporting configurations. The operations of 1210 may be performed in accordance with examples as disclosed herein. In some examples, aspects of the operations of 1210 may be performed by an inference parameter set to CSI reporting configuration mapping manager 1030 as described with reference to FIG. 10.

At 1215, the method may include transmitting one or more third control messages, where the one or more third control messages indicate whether the inference parameter set is applicable or non-applicable for CSI reporting based on the second control information (e.g., the mapping configuration). The operations of 1215 may be performed in accordance with examples as disclosed herein. In some examples, aspects of the operations of 1215 may be performed by a reporting manager 1035 as described with reference to FIG. 10.

The following provides an overview of aspects of the present disclosure:
Aspect 1: A method for wireless communications at a UE, comprising: transmitting a first control message that indicates a plurality of inference parameter sets supported by the UE; receiving, based at least in part on the first control message, a second control message comprising an indication that an inference parameter set of the plurality of inference parameter sets corresponds to one or more CSI reporting configurations; and transmitting one or more third control messages, wherein the one or more third control messages indicate whether the inference parameter set is applicable or non-applicable for CSI reporting based at least in part on the second control message.
Aspect 2: The method of aspect 1, wherein the second control message indicates that a first inference parameter set of the plurality of inference parameter sets is one-to-one mapped to a first CSI reporting configuration of the one or more CSI reporting configurations.
Aspect 3: The method of aspect 2, wherein the second control message indicates that a second inference parameter set of the plurality of inference parameter sets is one-to-one mapped to a second CSI reporting configuration of the one or more CSI reporting configurations.
Aspect 4: The method of aspect 3, wherein transmitting the one or more third control messages comprises: transmitting, after reception of the second control message, a third control message indicating that the first inference parameter set is applicable or non-applicable for CSI reporting.
Aspect 5: The method of any of aspects 3 through 4, further comprising: evaluating, after reception of the second control message, respective applicability statuses for the first inference parameter set, the first CSI reporting configuration, the second inference parameter set, the second CSI reporting configuration, and a third inference parameter set of the plurality of inference parameter sets.
Aspect 6: The method of aspect 5, wherein transmitting the one or more third control messages comprises: transmitting a third control message indicating that the first inference parameter set is applicable or non-applicable for CSI reporting based at least in part on the first inference parameter set or the first CSI reporting configuration becoming applicable or non-applicable for CSI reporting at the UE in accordance with the evaluating.
Aspect 7: The method of aspect 1, wherein the second control message indicates that the inference parameter set is mapped to a plurality of CSI reporting configurations.
Aspect 8: The method of aspect 7, wherein the second control message indicates that a second inference parameter set of the plurality of inference parameter sets is mapped to a second plurality of CSI reporting configurations.
Aspect 9: The method of aspect 8, further comprising: evaluating, after reception of the second control message, respective applicability statuses for the inference parameter set, the plurality of CSI reporting configurations, the second inference parameter set, the second plurality of CSI reporting configurations, and a third inference parameter set of the plurality of inference parameter sets.
Aspect 10: The method of aspect 9, wherein transmitting the one or more third control messages comprises: transmitting a third control message indicating that the inference parameter set has become applicable or non-applicable for CSI reporting at the UE in accordance with the evaluating.
Aspect 11: The method of any of aspects 9 through 10, wherein transmitting the one or more third control messages comprises: transmitting a third control message indicating that at least one CSI reporting configuration of the plurality of CSI reporting configurations have become applicable or non-applicable for CSI reporting at the UE in accordance with the evaluating.
Aspect 12: The method of aspect 1, wherein the second control message indicates the inference parameter set is mapped to a plurality of CSI reporting configurations and that each of the plurality of CSI reporting configurations is mapped to multiple inference parameter sets of the plurality of inference parameter sets.
Aspect 13: The method of aspect 12, further comprising: evaluating, after reception of the second control message, respective applicability statuses for the plurality of CSI reporting configurations, the multiple inference parameter sets, and a second inference parameter set of the plurality of inference parameter sets.
Aspect 14: The method of aspect 13, wherein transmitting the one or more third control messages comprises: transmitting a third control message indicating that the inference parameter set has become applicable or non-applicable for CSI reporting at the UE in accordance with the evaluating.
Aspect 15: The method of any of aspects 13 through 14, wherein transmitting the one or more third control messages comprises: transmitting a third control message indicating that at least one CSI reporting configuration of the plurality of CSI reporting configurations has become applicable or non-applicable for CSI reporting at the UE in accordance with the evaluating.
Aspect 16: The method of any of aspects 1 through 15, further comprising: receiving one or more reference signals in accordance with the one or more CSI reporting configurations; and transmitting one or more CSI reports in accordance with the one or more CSI reporting configurations, wherein the one or more CSI reports include predicted beam measurement values based at least in part on the one or more reference signals in accordance with the inference parameter set.
Aspect 17: The method of any of aspects 1 through 16, wherein the second control message indicates a mapping configuration that maps the inference parameter set of the plurality of inference parameter sets to the one or more CSI reporting configurations.
Aspect 18: A UE comprising one or more memories storing processor-executable code, and one or more processors coupled with the one or more memories and individually or collectively operable to execute the code to cause the UE to perform a method of any of aspects 1 through 17.
Aspect 19: A UE comprising at least one means for performing a method of any of aspects 1 through 17.
Aspect 20: A non-transitory computer-readable medium storing code the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Additionally, a “set” refers to one or more items, and a “subset” refers to less than a whole set, but non-empty.

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a first control message that indicates a plurality of inference parameter sets supported by the UE;
receive, based at least in part on the first control message, a second control message comprising an indication that an inference parameter set of the plurality of inference parameter sets corresponds to one or more channel state information reporting configurations; and
transmit one or more third control messages, wherein the one or more third control messages indicate whether the inference parameter set is applicable or non-applicable for channel state information reporting based at least in part on the second control message.

2. The UE of claim 1, wherein the second control message indicates that a first inference parameter set of the plurality of inference parameter sets is one-to-one mapped to a first channel state information reporting configuration of the one or more channel state information reporting configurations.

3. The UE of claim 2, wherein the second control message indicates that a second inference parameter set of the plurality of inference parameter sets is one-to-one mapped to a second channel state information reporting configuration of the one or more channel state information reporting configurations.

4. The UE of claim 3, wherein, to transmit the one or more third control messages, the one or more processors are individually or collectively operable to execute the code to cause the UE to:
transmit, after reception of the second control message, a third control message indicating that the first inference parameter set is applicable or non-applicable for channel state information reporting.

5. The UE of claim 3, wherein the one or more processors are individually or collectively further operable to execute the code to cause the UE to:
evaluate, after reception of the second control message, respective applicability statuses for the first inference parameter set, the first channel state information reporting configuration, the second inference parameter set, the second channel state information reporting configuration, and a third inference parameter set of the plurality of inference parameter sets.

6. The UE of claim 5, wherein, to transmit the one or more third control messages, the one or more processors are individually or collectively operable to execute the code to cause the UE to:
transmit a third control message indicating that the first inference parameter set is applicable or non-applicable for channel state information reporting based at least in part on the first inference parameter set or the first channel state information reporting configuration becoming applicable or non-applicable for channel state information reporting at the UE in accordance with the evaluating.

7. The UE of claim 1, wherein the second control message indicates that the inference parameter set is mapped to a plurality of channel state information reporting configurations.

8. The UE of claim 7, wherein the second control message indicates that a second inference parameter set of the plurality of inference parameter sets is mapped to a second plurality of channel state information reporting configurations.

9. The UE of claim 8, wherein the one or more processors are individually or collectively further operable to execute the code to cause the UE to:
evaluate, after reception of the second control message, respective applicability statuses for the inference parameter set, the plurality of channel state information reporting configurations, the second inference parameter set, the second plurality of channel state information reporting configurations, and a third inference parameter set of the plurality of inference parameter sets.

10. The UE of claim 9, wherein, to transmit the one or more third control messages, the one or more processors are individually or collectively operable to execute the code to cause the UE to:
transmit a third control message indicating that the inference parameter set has become applicable or non-applicable for channel state information reporting at the UE in accordance with the evaluating.

11. The UE of claim 9, wherein, to transmit the one or more third control messages, the one or more processors are individually or collectively operable to execute the code to cause the UE to:
transmit a third control message indicating that at least one channel state information reporting configuration of the plurality of channel state information reporting configurations have become applicable or non-applicable for channel state information reporting at the UE in accordance with the evaluating.

12. The UE of claim 1, wherein the second control message indicates the inference parameter set is mapped to a plurality of channel state information reporting configurations and that each of the plurality of channel state information reporting configurations is mapped to multiple inference parameter sets of the plurality of inference parameter sets.

13. The UE of claim 12, wherein the one or more processors are individually or collectively further operable to execute the code to cause the UE to:
evaluate, after reception of the second control message, respective applicability statuses for the plurality of channel state information reporting configurations, the multiple inference parameter sets, and a second inference parameter set of the plurality of inference parameter sets.

14. The UE of claim 13, wherein, to transmit the one or more third control messages, the one or more processors are individually or collectively operable to execute the code to cause the UE to:
transmit a third control message indicating that the inference parameter set has become applicable or non-applicable for channel state information reporting at the UE in accordance with the evaluating.

15. The UE of claim 13, wherein, to transmit the one or more third control messages, the one or more processors are individually or collectively operable to execute the code to cause the UE to:
transmit a third control message indicating that at least one channel state information reporting configuration of the plurality of channel state information reporting configurations has become applicable or non-applicable for channel state information reporting at the UE in accordance with the evaluating.

16. The UE of claim 1, wherein the one or more processors are individually or collectively further operable to execute the code to cause the UE to:
receive one or more reference signals in accordance with the one or more channel state information reporting configurations; and
transmit one or more channel state information reports in accordance with the one or more channel state information reporting configurations, wherein the one or more channel state information reports include predicted beam measurement values based at least in part on the one or more reference signals in accordance with the inference parameter set.

17. The UE of claim 1, wherein the second control message indicates a mapping configuration that maps the inference parameter set of the plurality of inference parameter sets to the one or more channel state information reporting configurations.

18. A method for wireless communications at a user equipment (UE), comprising:
transmitting a first control message that indicates a plurality of inference parameter sets supported by the UE;
receiving, based at least in part on the first control message, a second control message comprising an indication that an inference parameter set of the plurality of inference parameter sets corresponds to one or more channel state information reporting configurations; and
transmitting one or more third control messages, wherein the one or more third control messages indicate whether the inference parameter set is applicable or non-applicable for channel state information reporting based at least in part on the second control message.

19. The method of claim 18, wherein the second control message indicates that a first inference parameter set of the plurality of inference parameter sets is one-to-one mapped to a first channel state information reporting configuration of the one or more channel state information reporting configurations.

20. A non-transitory computer-readable medium storing code for wireless communications at a user equipment (UE), the code comprising instructions executable by one or more processors to:
transmit a first control message that indicates a plurality of inference parameter sets supported by the UE;
receive, based at least in part on the first control message, a second control message comprising an indication that an inference parameter set of the plurality of inference parameter sets corresponds to one or more channel state information reporting configurations; and
transmit one or more third control messages, wherein the one or more third control messages indicate whether the inference parameter set is applicable or non-applicable for channel state information reporting based at least in part on the second control message.
